(19) United States
(12) Patent Application Publication
(10) Pub. No.: US 2017/0039406 A1
(43) Pub. Date: Feb. 9, 2017

(54) EXTINGUISHER WITH TRACKING DEVICE AND MONITORING INSTALLATION FOR VEHICLES

(71) Applicant: Augusto de Jesus Delgado, JR., Goiania (BR)

(72) Inventor: Augusto de Jesus Delgado, JR., Goiania (BR)

(21) Appl. No.: 14/817,339

(22) Filed: Aug. 4, 2015

(51) Int. Cl. G06K 7/10

(52) U.S. Cl. CPC G06K 7/10366

(57) ABSTRACT

An extinguisher with a tracking device and vehicle monitoring feature. A fire extinguisher has at least one wall and a siphon tube operatively connected thereto. A radio frequency transponder is also provided. An active tag is mounted inside the wall of the fire extinguisher or the siphon tube. At least one reader is installed in a traffic light pole, tower, light pole, or existing radar positions on public roads. The radio frequency transponder uses a UHF frequency of up to 985 MHz or a microwave radio frequency communication between 1.0 and 5.8 GHz. The extinguisher allows communication with the readers, whether fixed or mobile, wherein such antennas with fixed readers will capture and transmit data at a distance of approximately one hundred meters which will be installed in the traffic lights pole that exist on public roads of cities or in street lamps, in order to allow the monitoring of both the extinguisher of the vehicle as well as the vehicle itself, so that if the driver of the vehicle removes the extinguishing vehicle, or moves to a distance of more than three meters from the active tag, it sends a signal to the reader, indicating that communication was lost between both tags. The vehicle must be checked by an authority or nearest vehicle.

### FIELD OF THE INVENTION

This invention relates to fire extinguishers for vehicles and, more particularly, to a fire extinguisher having a radio frequency electronic device to allow communication with readers for monitoring both the extinguisher and the vehicle itself.

### BACKGROUND OF THE INVENTION

Radio frequency identification technology is wireless AIDC technology that uses radio signals to remotely identify an object and store or recover information on the object. Such information is stored in a device called a tag which is placed in the object to identify objects, recover information, and provide that information to data processing systems automatically.

The passive identification tag (passive tag) has no power source itself and obtains the power it needs for operation from the signal emitted by the reader, made up of only a chip and an antenna to which it applies, a radio frequency (RF) signal to communicate and operate in high and low frequency bands while obtaining power from the signal emitted by the reader through a magnetic induction process.

The active identification tag (active tag) has an internal power source (battery) that supplies and allows communication with the reader or with other passive tags, allowing for the integrated circuits to make it possible to increase the reading distance, allowing communication with RFID reader or other tags, thereby forming a network. The system can incorporate sensors that record changes in certain variables and are used to know the development of variables such as temperature, pressure or humidity, or preset data supplied to the object in question.

The RFID reader identifies or recovers the information stored in the tag, either active or passive, and to establish communications with the “middleware” of the “subsystem” of the company that interconnects the various components of the information management system, which receives the information processed and is made available for user processes. The middleware is responsible for the interface of the specific system used for RFID comprising readers, tags, and its communication infrastructure and management system. The incorporation of software allows recording of communications between the tag and the reader by requesting the necessary information from the database and provides this information to the reader so it may dialogue with the tag and receive information from the reader to be saved and update the databases that maintain the synchronization among everything involved in the process.

Thus, this invention takes on an innovation with respect to the identification system, tracking and monitoring of extinguishers, to allow the communication of the active tag installed inside it with the passive tag inside the vehicle and the communication of both tags with the reader installed in present towers or poles in order to analyze the data stored in the tags and cross them with the data stored in the databases of the management system.

### DESCRIPTION OF RELATED ART

European Patent application EP-0389406 refers to a tire that includes an electronic element which has a passive transponder for radio frequency identification, commonly known by the acronym RFID, that has two antennas forming a pair of poles, the specific purpose of which is data storage.

Also, United States Patent application no. 2008/0289736 dated Nov. 27, 2008, includes an electronic element installed in a tire with the same purpose of storing data and transmits them by long distance in an optimum manner. The manufacturing method of this tire prioritizes the packaging of such electronic element in three layers of rubber surrounded by a metal layer of ring reinforcement installed radially in the axis of the electronic element at a distance of 10 to 15 mm from the edge of the tire.

### SUMMARY OF THE INVENTION

In accordance with the present invention, there is provided an extinguisher with a tracking device and vehicle monitoring feature. A fire extinguisher has at least one wall and a siphon tube operatively connected thereto. A radio frequency transponder is also provided. An active tag is mounted inside the wall of the fire extinguisher or the siphon tube. At least one reader is installed in a traffic light pole, tower, light pole, or existing radar positions on public roads. The radio frequency transponder uses a UHF frequency of up to 985 MHz or a microwave radio frequency communication between 1.0 and 5.8 GHz.

### BRIEF DESCRIPTION OF THE DRAWINGS

A complete understanding of the present invention may be obtained by reference to the accompanying drawing, when considered in conjunction with the subsequent detailed description, in which:

FIG. 1 shows an extinguisher model with round top and lower ends according to polymer extinguisher models, with internal views, containing an electronic device, active tag attached to the siphon tube, in accordance with the present invention;

FIG. 2 Illustrates an extinguisher model with straight edges like already-existing steel extinguisher models with an internal view that contains an electronic device—active tag—adhered inside the siphon tube, but with an extension of such tag, which appears with a top view, showing the antenna (AT), the chip (CH) and the battery (BT); and

FIG. 3 shows the electronic device—the passive tag, which contains only the antenna (AT) and/or the chip (CH).

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

The invention is an extinguisher with a tracking device and vehicle monitoring feature. A fire extinguisher has at least one wall and a siphon tube operatively connected thereto. A radio frequency transponder is also provided. An active tag is mounted inside the wall of the fire extinguisher or the siphon tube. At least one reader is installed in a traffic light pole, tower, light pole, or existing radar positions on public roads. The radio frequency transponder uses a UHF frequency of up to 985 MHz or a microwave radio frequency communication between 1.0 and 5.8 GHz.

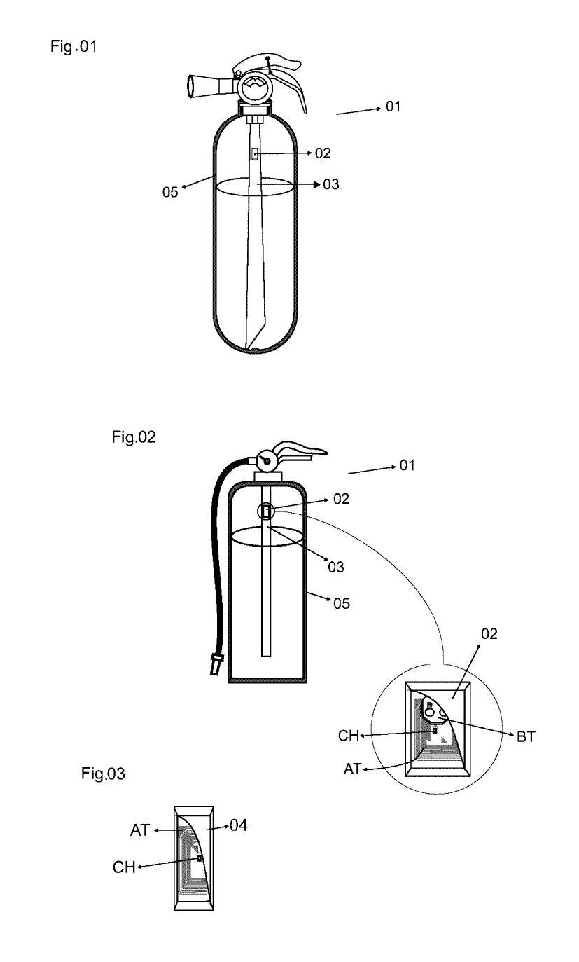

As can be seen by referring now to FIGS. 1-3, this extinguisher includes the extinguisher 01 itself which is equipped with a passive tag 02 installed inside, that can also be installed on the inside wall of the container 05 or siphon tube 03. The active tag 02 is equipped with batteries (BT), a miniature electronic circuit chip (CH) and antenna (AT), while the passive tag 04 does not have the battery and therefore does not have its own power source obtaining the energy it needs to operate from the signal emitted by the reader.

The installation of extinguisher 01 to a vehicle, not shown, includes the installation and configuration of a passive tag 04 in the vehicle, preferably in a location difficult to locate and unknown to the driver who will have close communication to an active tag 02 which is inside the extinguisher 01. If the driver of the vehicle removes the extinguisher from the vehicle, or moves it from the active tag 02 to a distance greater than three meters, the passive tag 04 sends the signal to the nearest reader that there is no communication between the two tags 02, 04. The vehicle must be checked by an authority or in the nearest location.

However, as a means to monitor vehicles, fixed or mobile readers are installed where such fixed reader has data-capturing and transmission antennas for a distance of approximately one hundred meters and are installed in the towers/poles (portals) of existing traffic lights on public roads in cities, public lighting poles, or even in radar poles existing on public roads or along highways Therefore a large network of existing towers is available for use, benefitting both the population and the municipal and state authorities. Mobile readers are installed in police cars so that the data capturing and transmission antenna can reach a preset distance. When a car crosses with any other irregular vehicle or receives information from readers from any other extinguisher with its active tag left the scope of communication of the passive tag of the vehicle, this vehicle is notified, making police checks easier.

Therefore, the reader, both fixed and mobile, when crossed with the signal of the transponder, meaning, with the RFID signal makes it possible for the crossing of data both from the active tag 02 as well as the passive tag 04, and verifying basic information including but not limited to tax payments, validity of extinguisher, driver information, and other preset or regulated information and included in the traffic regulator database, such as stolen vehicles.

This disclosure of the use of radio frequency identification technology which uses a UHF frequency of up to 985 MHz, is not intended to cover all possibilities of new frequencies or eliminate RF microwave communication which is around 1 to 5.8 GHz, most suitable in cases of active or passive tag installation in waterproof material.

This invention allows vehicle monitoring by obtaining basic information or its registered information, so that the vehicle does not travel without the mentioned extinguisher 01. Note that in most countries, traffic law establishes the extinguisher as a type of mandatory safety equipment and if no such law exists, it is customary for all vehicle manufacturers to add such equipment. Such extinguishers have an active tag 0) inside, linking to the passive tag 04 inside the vehicle and in turn both linking to the readers.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

1: An extinguisher with a tracking device and vehicle monitoring feature, comprising:
a) a fire extinguisher for placement in a vehicle, said fire extinguisher having at least one wall and a siphon tube operatively connected thereto;
b) a radio frequency transponder; and
c) an active tag mounted inside one of the following elements: said wall of said fire extinguisher and said siphon tube thereof, said active tag including data representative of at least one of the following: tax payments, driver information, and other preset or regulated information.

2: The extinguisher with tracking device and vehicle monitoring feature in accordance with claim 1, further comprising a passive tag inside a vehicle to communicate with said active tag to communicate with readers.

3: The extinguisher with tracking device and vehicle monitoring feature in accordance with claim 2, further comprising at least one reader for capturing and transmitting data from and to said active tag and said passive tag inside the vehicle.

4: The extinguisher with tracking device and vehicle monitoring feature in accordance with claim 3, wherein said at least one reader is installed in at least one of the following: traffic light poles, towers, light poles, and existing radar positions on public roads.

5: The extinguisher with tracking device and vehicle monitoring feature in accordance with claim 3, wherein said active tag is linked to said passive tag, and basic information is obtained from said radio frequency transponder to indicate whether said vehicle is travelling with said extinguisher.

6: The extinguisher with tracking device and vehicle monitoring installation in accordance with claim 1, wherein said radio frequency transponder uses at least one of the following frequencies: a UHF frequency of up to 985 MHz and a microwave radio frequency communication between 1.0 and 5.8 GHz.
